(19) United States
(12) Patent Application Publication
(10) Pub. No.: US 2019/0176128 A1
(43) Pub. Date: Jun. 13, 2019

(54) NH3 ABATEMENT WITH GREATER SELECTIVITY TO N2

(71) Applicant: JOHNSON MATTHEY PUBLIC LIMITED COMPANY, London (GB)

(72) Inventors: David MICALLEF, Royston (GB); Andrew NEWMAN, Royston (GB); Alex Connel PARSONS, Barkway (GB)

(21) Appl. No.: 16/217,463

(22) Filed: Dec. 12, 2018

Related U.S. Application Data
(60) Provisional application No. 62/598,059, filed on Dec. 13, 2017.

(51) Int. Cl. B01J 23/42; B01J 29/76; B01J 29/68; B01J 29/24; F01N 3/20

(52) U.S. Cl. CPC B01J 23/42; B01J 29/763; B01J 29/7615; B01J 29/68; B01J 29/24; B01J 21/04; B01J 2523/17; B01J 2229/60; B01J 2523/842; F01N 2510/063; F01N 2510/0684; F01N 3/208

(57) ABSTRACT

Catalysts having a first catalyst coating and a second catalyst coating, the first catalyst coating including a blend of 1) Pt on a support, and 2) a molecular sieve, and the second catalyst coating including an SCR catalyst.

### BACKGROUND OF THE INVENTION

Hydrocarbon combustion in diesel engines, stationary gas turbines, and other systems generates exhaust gas that must be treated to remove nitrogen oxides (NOx), which comprises NO (nitric oxide) and NO₂ (nitrogen dioxide), with NO being the majority of the NOx formed. NOx is known to cause a number of health issues in people as well as causing a number of detrimental environmental effects including the formation of smog and acid rain. To mitigate both the human and environmental impact from NOₓ in exhaust gas, it is desirable to eliminate these undesirable components, preferably by a process that does not generate other noxious or toxic substances.

Exhaust gas generated in lean-burn and diesel engines is generally oxidative. NOx needs to be reduced selectively with a catalyst and a reductant in a process known as selective catalytic reduction (SCR) that converts NOx into elemental nitrogen (N₂) and water. In an SCR process, a gaseous reductant, typically anhydrous ammonia, aqueous ammonia, or urea, is added to an exhaust gas stream prior to the exhaust gas contacting the catalyst. The reductant is absorbed onto the catalyst and the NOₓ is reduced as the gases pass through or over the catalyzed substrate. In order to maximize the conversion of NOx, it is often necessary to add more than a stoichiometric amount of ammonia to the gas stream. However, release of the excess ammonia into the atmosphere would be detrimental to the health of people and to the environment. In addition, ammonia is caustic, especially in its aqueous form. Condensation of ammonia and water in regions of the exhaust line downstream of the exhaust catalysts can result in a corrosive mixture that can damage the exhaust system. Therefore, the release of ammonia in exhaust gas should be eliminated. In many conventional exhaust systems, an ammonia oxidation catalyst (also known as an ammonia slip catalyst or “ASC”) is installed downstream of the SCR catalyst to remove ammonia from the exhaust gas by converting it to nitrogen. The use of ammonia slip catalysts can allow for NOₓ conversions of greater than 90% over a typical diesel driving cycle.

It would be desirable to have a catalyst that provides for both NOx removal by SCR and for selective ammonia conversion to nitrogen, where ammonia conversion occurs over a wide range of temperatures in a vehicle's driving cycle, and minimal nitrogen oxide and nitrous oxide by-products are formed.

### SUMMARY OF THE INVENTION

According to some embodiments of the present invention, a catalyst comprises a first catalyst coating and a second catalyst coating, where the first catalyst coating comprises a blend of 1) Pt on a support, and 2) a molecular sieve, and the second catalyst coating comprises an SCR catalyst.

In some embodiments, the SCR catalyst comprises a Cu-SCR catalyst comprising copper and a molecular sieve, and/or an Fe-SCR catalyst comprising iron and a molecular sieve. The support may include, for example, one or more of: silica, titania, and/or Me-doped alumina or titania where Me comprises a metal selected from W, Mn, Fe, Bi, Ba, La, Ce, Zr, or mixtures of two or more thereof. In some embodiments, the molecular sieve comprises FER, BEA, CHA, AEI, MOR, MFI, and mixtures and intergrowths thereof. In some embodiments, Pt is present in an amount of about 1 g/ft³ to about 10 g/ft³ relative to the weight of the first catalyst coating. In some embodiment, the molecular sieve is present in an amount of up to about 2 g/in³ relative to the weight of the first catalyst coating.

In some embodiments, the first and second catalyst coatings are configured such that exhaust gas contacts the second catalyst coating before contacting the first catalyst coating. In certain embodiments, the second catalyst coating completely overlaps the first catalyst coating. In some embodiments, the second catalyst coating partially overlaps the first catalyst coating. In other embodiments, the first catalyst coating and the second catalyst coating do not overlap.

In some embodiments, the first catalyst coating comprises a platinum group metal on the molecular sieve. The molecular sieve may comprise a metal exchanged molecular sieve; the metal may comprise, for example, copper and/or iron.

In some embodiments, a catalytic article may include a catalyst described herein and a substrate. A suitable substrate may include, for example, cordierite, a high porosity cordierite, a metallic substrate, an extruded SCR, a wall flow filter, a filter, or an SCRF.

According to some embodiments of the present invention, an emissions treatment system comprises: a) a diesel engine emitting an exhaust stream including particulate matter, NOx, and carbon monoxide; and b) a catalyst as described herein (“the SCR/ASC”). In some embodiments, the system may include an upstream SCR catalyst upstream of the SCR/ASC. In some embodiments, the upstream SCR catalyst is close-coupled with the SCR/ASC. In certain embodiments, the upstream SCR catalyst and the SCR/ASC catalyst are located on a single substrate, and the upstream SCR catalyst is located on an inlet side of the substrate and the SCR/ASC catalyst is located on the outlet side of the substrate.

According to some embodiments of the present invention, a method of reducing emissions from an exhaust stream comprises contacting the exhaust stream with a catalyst described herein. In some embodiments, the catalyst provides lower peak N₂O emissions compared to a catalyst which is equivalent except does not include a molecular sieve in the first catalyst coating. In some embodiments, the catalyst provides at least about 25% reduction in peak N₂O emissions compared to a catalyst which is equivalent except does not include a molecular sieve in the first catalyst coating.

### BRIEF DESCRIPTION OF THE DRAWINGS

FIG. 1 depicts a catalyst configuration having a first catalyst coating extending from the outlet end toward the inlet end, covering less than the entire axial length of the substrate, and a second catalyst coating extending from the inlet end toward the outlet end, covering less than the entire axial length of the substrate and overlapping a portion of the first catalyst coating.

FIG. 2 depicts a catalyst configuration having a first catalyst coating extending from the outlet end toward the inlet end, covering less than the entire axial length of the substrate, and a second catalyst coating covering the entire axial length of the substrate and overlapping the first catalyst coating.

FIG. 3 depicts a catalyst configuration having a first catalyst coating covering the entire axial length of the substrate, and a second catalyst coating extending from the inlet end toward the outlet end, covering less than the entire axial length of the substrate and overlapping a portion of the first catalyst coating.

FIG. 4 depicts a catalyst configuration having a first catalyst coating covering the entire axial length of the substrate, and a second catalyst coating covering the entire axial length of the substrate and overlapping the first catalyst coating.

FIG. 5 depicts a catalyst configuration having a first catalyst coating extending from the outlet end toward the inlet end, covering less than the entire axial length of the substrate, and a second catalyst coating extending from the inlet end toward the outlet end and covering less than the entire axial length of the substrate, and where the first and second catalyst coatings do not overlap.

FIG. 6 depicts a catalyst configuration having a first catalyst coating extending from the outlet end toward the inlet end, covering less than the entire axial length of the substrate, and a second catalyst coating extending from the inlet end toward the outlet end and covering less than the entire axial length of the substrate, and where the first and second catalyst coatings do not overlap. The catalyst includes a further catalyst coating covering at least part of the first catalyst coating.

FIG. 7 depicts a catalyst configuration having a first catalyst coating extending from the outlet end toward the inlet end, covering less than the entire axial length of the substrate, and a second catalyst coating extending from the inlet end toward the outlet end, covering less than the entire axial length of the substrate, and where the first and second catalyst coatings do not overlap and have a space between them.

FIG. 8 depicts a catalyst configuration having an extruded SCR substrate, where the first and second coating may be located on the outlet end of the substrate.

FIG. 9 depicts a catalyst configuration having an extruded SCR substrate, where a first catalyst coating extends from the outlet end toward the inlet end, covering less than the entire axial length of the substrate, and a second catalyst coating also extends from the outlet end toward the inlet end, which fully covers the first catalyst coating and extends some distance beyond but not covering the entire axial length of the substrate.

FIG. 10 shows NH₃ conversion and N₂O selectivity test results.

### DETAILED DESCRIPTION OF THE INVENTION

Catalysts of the present invention relate to catalyst articles having selective catalytic reduction (SCR) and ammonia slip catalyst (ASC) functionality. The catalyst article may have a layer including an SCR catalyst (which may be referred to herein as the second catalyst coating), and a layer including a blend of 1) platinum on a support, and 2) a molecular sieve (which may be referred to herein as the first catalyst coating). Traditionally, such catalyst articles have included SCR functionality in the top or front layer, and ASC functionality in a bottom or rear layer. In catalyst of the present invention, the catalyst coatings may be arranged such that the exhaust gas contacts the second catalyst coating before contacting the first catalyst coating. It has surprisingly been found that including a molecular sieve in both a first and second layer provides various benefits and advantages to NH₃ conversion, as well as zoned ASC configurations with desirable selectivity and catalyst activity. Specifically, incorporating molecular sieves such as zeolites and metal-zeolites into the oxidation component of an ASC may improve NH₃ abatement and the selectivity to N₂.

Catalytic articles of the present invention may have various configurations on a substrate having an axial length. In some embodiments, the catalytic article has a first catalyst coating extending from the outlet end toward the inlet end, covering less than the entire axial length of the substrate, and a second catalyst coating extending from the inlet end toward the outlet end, covering less than the entire axial length of the substrate and overlapping a portion of the first catalyst coating.

In some embodiments, the catalytic article has a first catalyst coating extending from the outlet end toward the inlet end, covering less than the entire axial length of the substrate, and a second catalyst coating covering the entire axial length of the substrate and overlapping the first catalyst coating.

In some embodiments, the catalytic article has a first catalyst coating covering the entire axial length of the substrate, and a second catalyst coating extending from the inlet end toward the outlet end, covering less than the entire axial length of the substrate and overlapping a portion of the first catalyst coating.

In some embodiments, the catalytic article has a first catalyst coating covering the entire axial length of the substrate, and a second catalyst coating covering the entire axial length of the substrate and overlapping the first catalyst coating.

In some embodiments, the catalytic article has a first catalyst coating extending from the outlet end toward the inlet end, covering less than the entire axial length of the substrate, and a second catalyst coating extending from the inlet end toward the outlet end, covering less than the entire axial length of the substrate, and where the first and second catalyst coating do not overlap.

In some embodiments, the catalytic article has a first catalyst coating extending from the outlet end toward the inlet end, covering less than the entire axial length of the substrate, and a second catalyst coating extending from the inlet end toward the outlet end and covering less than the entire axial length of the substrate, where the first and second catalyst coatings do not overlap, and a further catalyst coating extending from the outlet end and covering at least part of the first catalyst coating.

In some embodiments, the catalytic article has a first catalyst coating extending from the outlet end toward the inlet end, covering less than the entire axial length of the substrate, and a second catalyst coating extending from the inlet end toward the outlet end, covering less than the entire axial length of the substrate, and where the first and second catalyst coatings do not overlap and have a space between them.

In some embodiments, the substrate is an extruded SCR. In some embodiments with an extruded substrate, at least a portion of the extruded substrate is left uncoated. In some embodiments, the first and second coating may be located on the outlet end of the extruded substrate. In some embodiments, the second coating extends further toward the inlet end of the substrate than the first coating.

Ammonia Oxidation Catalyst

Catalyst articles of the present invention may include one or more ammonia oxidation catalysts, also called an ammonia slip catalyst (“ASC”). One or more ASC may be included with or downstream from an SCR catalyst, to oxidize excess ammonia and prevent it from being released to the atmosphere. In some embodiments the ASC may be included on the same substrate as an SCR catalyst, or blended with an SCR catalyst. In certain embodiments, the ASC material may be selected to favor the oxidation of ammonia to nitrogen instead of the formation of NOₓ or N₂O. Preferred catalyst materials include platinum, palladium, or a combination thereof. The ASC may comprise platinum and/or palladium supported on a support. In some embodiments the support may include a metal oxide. In some embodiments, the support may include silica, titania, and/or Me-doped alumina or titania where Me could be a metal from the list W, Mn, Fe, Bi, Ba, La, Ce, Zr, or mixtures of two or more thereof. In some embodiments, the ASC may comprise platinum and/or palladium supported on a molecular sieve such as a zeolite. In some embodiments, the catalyst is disposed on a high surface area support, including but not limited to alumina.

In some embodiments, an ASC may include a blend of: 1) a platinum group metal on a support, and 2) a molecular sieve. The ASC may comprise, consist essentially of, or consist of, a blend of: 1) a platinum group metal on a support, and 2) a molecular sieve. In some embodiments, the molecular sieve comprises a zeolite. In some embodiments, the molecular sieve includes a metal exchanged molecular sieve; the metal may include, for example, copper and/or iron. In some embodiments, a suitable molecular sieve includes, for example, FER, BEA, CHA, AEI, MOR, MFI, and mixtures and intergrowths thereof. The molecular sieve may include any of the molecular sieves described in detail below.

In some embodiments, an ASC may include a platinum group metal in an amount of about 1 g/ft³ to about 10 g/ft³; about 1 g/ft³ to about 5 g/ft³; about 1 g/ft³ to about 3 g/ft³; about 1 g/ft³; about 2 g/ft³; about 3 g/ft³; about 4 g/ft³; about 5 g/ft³; about 6 g/ft³; about 7 g/ft³; about 8 g/ft³; about 9 g/ft³; or about 10 g/ft³, relative to the total volume of the ASC.

In some embodiments, an ASC may include a molecular sieve in an amount of up to about 2 g/in³; about 0.1 g/in³ to about 2 g/in³; about 0.1 g/in³ to about 1 g/in³; about 0.1 g/in³ to about 0.5 g/in³; about 0.2 g/in³ to about 0.5 g/in³; about 0.1 g/in³; about 0.2 g/in³; about 0.3 g/in³; about 0.4 g/in³; about 0.5 g/in³; about 1 g/in³; about 1.5 g/in³; or about 2 g/in³, relative to the total volume of the ASC.

In some embodiments, the ASC comprises a platinum group metal distributed on a molecular sieve. The ASC may comprise, consist of, or consist essentially of, a molecular sieve based ASC formulation.

In general, a molecular sieve included in the ASC may comprise a molecular sieve having an aluminosilicate framework (e.g. zeolite), an aluminophosphate framework (e.g. AlPO), a silicoaluminophosphate framework (e.g. SAPO), a heteroatom-containing aluminosilicate framework, a heteroatom-containing aluminophosphate framework (e.g. MeAlPO, where Me is a metal), or a heteroatom-containing silicoaluminophosphate framework (e.g. MeSAPO, where Me is a metal). The heteroatom (i.e. in a heteroatom-containing framework) may be selected from the group consisting of boron (B), gallium (Ga), titanium (Ti), zirconium (Zr), zinc (Zn), iron (Fe), vanadium (V) copper (Cu) and combinations of any two or more thereof. It is preferred that the heteroatom is a metal (e.g. each of the above heteroatom-containing frameworks may be a metal-containing framework).

The description of molecular sieves herein describes molecular sieves that may be suitable as a support for a platinum based metal and/or as a component blended with a platinum based metal on support. In some embodiments, a molecular sieve present in an ASC comprises, or consists essentially of, a molecular sieve having an aluminosilicate framework (e.g. zeolite) or a silicoaluminophosphate framework (e.g. SAPO).

When the molecular sieve has an aluminosilicate framework (e.g. the molecular sieve is a zeolite), then typically the molecular sieve has a silica to alumina molar ratio (SAR) of from 5 to 200 (e.g. 10 to 200), 10 to 100 (e.g. 10 to 30 or 20 to 80), such as 12 to 40, or 15 to 30. In some embodiments, a suitable molecular sieve has a SAR of >200; >600; or >1200. In some embodiments, the molecular sieve has a SAR of from about 1500 to about 2100.

Typically, the molecular sieve is microporous. A microporous molecular sieve has pores with a diameter of less than 2 nm (e.g. in accordance with the IUPAC definition of “microporous” [see Pure & Appl. Chem., 66(8), (1994), 1739-1758)]).

A molecular sieve included in an ASC may comprise a small pore molecular sieve (e.g. a molecular sieve having a maximum ring size of eight tetrahedral atoms), a medium pore molecular sieve (e.g. a molecular sieve having a maximum ring size of ten tetrahedral atoms) or a large pore molecular sieve (e.g. a molecular sieve having a maximum ring size of twelve tetrahedral atoms) or a combination of two or more thereof.

When the molecular sieve is a small pore molecular sieve, then the small pore molecular sieve may have a framework structure represented by a Framework Type Code (FTC) selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, LTA, KFI, MER, MON, NSI, OWE, PAU, PHI, RHO, RTH, SAT, SAV, SFW, SIV, THO, TSC, UEI, UFI, VNI, YUG and ZON, or a mixture and/or an intergrowth of two or more thereof. Preferably, the small pore molecular sieve has a framework structure represented by a FTC selected from the group consisting of CHA, LEV, AEI, AFX, ERI, LTA, SFW, KFI, DDR and ITE. More preferably, the small pore molecular sieve has a framework structure represented by a FTC selected from the group consisting of CHA and AEI. The small pore molecular sieve may have a framework structure represented by the FTC CHA. The small pore molecular sieve may have a framework structure represented by the FTC AEI. When the small pore molecular sieve is a zeolite and has a framework represented by the FTC CHA, then the zeolite may be chabazite.

When the molecular sieve is a medium pore molecular sieve, then the medium pore molecular sieve may have a framework structure represented by a Framework Type Code (FTC) selected from the group consisting of AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, −PAR, PCR, PON, PUN, RRO, RSN, SFF, SFG, STF, STI, STT, STW, −SVR, SZR, TER, TON, TUN, UOS, VSV, WEI and WEN, or a mixture and/or an intergrowth of two or more thereof. Preferably, the medium pore molecular sieve has a framework structure represented by a FTC selected from the group consisting of FER, MEL, MFI, and STT. More preferably, the medium pore molecular sieve has a framework structure represented by a FTC selected from the group consisting of FER and MFI, particularly MFI. When the medium pore molecular sieve is a zeolite and has a framework represented by the FTC FER or MFI, then the zeolite may be ferrierite, silicalite or ZSM-5.

When the molecular sieve is a large pore molecular sieve, then the large pore molecular sieve may have a framework structure represented by a Framework Type Code (FTC) selected from the group consisting of AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, −RON, RWY, SAF, SAO, SBE, SBS, SBT, SEW, SFE, SFO, SFS, SFV, SOF, SOS, STO, SSF, SSY, USI, UWY, and VET, or a mixture and/or an intergrowth of two or more thereof. Preferably, the large pore molecular sieve has a framework structure represented by a FTC selected from the group consisting of AFI, BEA, MAZ, MOR, and OFF. More preferably, the large pore molecular sieve has a framework structure represented by a FTC selected from the group consisting of BEA, MOR and MFI. When the large pore molecular sieve is a zeolite and has a framework represented by the FTC BEA, FAU or MOR, then the zeolite may be a beta zeolite, faujasite, zeolite Y, zeolite X or mordenite.

In some embodiments, a platinum group metal is present on the support in an amount of about 0.1 wt % to about 10 wt % of the total weight of the platinum group metal and the support; about 0.1 wt % to about 6 wt % of the total weight of the platinum group metal and the support; about 0.1 wt % to about 5 wt % of the total weight of the platinum group metal and the support; about 0.1 wt % to about 4 wt % of the total weight of the platinum group metal and the support; about 0.1 wt % of the total weight of the platinum group metal and the support; about 0.3 wt % of the total weight of the platinum group metal and the support; about 0.5 wt % of the total weight of the platinum group metal and the support; about 1 wt % of the total weight of the platinum group metal and the support; about 2 wt % of the total weight of the platinum group metal and the support; about 3 wt % of the total weight of the platinum group metal and the support; about 4 wt % of the total weight of the platinum group metal and the support; about 5 wt % of the total weight of the platinum group metal and the support; about 6 wt % of the total weight of the platinum group metal and the support; about 7 wt % of the total weight of the platinum group metal and the support; about 8 wt % of the total weight of the platinum group metal and the support; about 9 wt % of the total weight of the platinum group metal and the support; or about 10 wt % of the total weight of the platinum group metal and the support. When the support comprises a non-zeolite support, a platinum group metal may be present on the support in an amount of about 0.05 wt % to about 1 wt % of the total weight of the platinum group metal and the support; about 0.1 wt % to about 1 wt % of the total weight of the platinum group metal and the support; about 0.1 wt % to about 0.7 wt % of the total weight of the platinum group metal and the support; about 0.1 wt % to about 0.5 wt % of the total weight of the platinum group metal and the support; about 0.2 wt % to about 0.4 wt % of the total weight of the platinum group metal and the support; or about 0.3 wt % of the total weight of the platinum group metal and the support. When the support comprises a zeolite support, a platinum group metal may be present on the support in an amount of about 0.5 wt % to about 10 wt % of the total weight of the platinum group metal and the support; about 0.5 wt % to about 7 wt % of the total weight of the platinum group metal and the support; about 1 wt % to about 5 wt % of the total weight of the platinum group metal and the support; about 2 wt % to about 4 wt % of the total weight of the platinum group metal and the support; or about 0.3 wt % of the total weight of the platinum group metal and the support.

In some embodiments, a catalyst article may include an ASC composition in a first catalyst coating and an ASC composition in a second catalyst coating. In some embodiments, the ASC compositions in the first and second catalyst coatings may comprise the same formulation as each other. In some embodiments, the ASC compositions in the first and second catalyst coatings may comprise different formulations than each other.

SCR Catalyst

Systems of the present invention may include one or more SCR catalyst.

The exhaust system of the invention may include an SCR catalyst which is positioned downstream of an injector for introducing ammonia or a compound decomposable to ammonia into the exhaust gas. The SCR catalyst may be positioned directly downstream of the injector for injecting ammonia or a compound decomposable to ammonia (e.g. there is no intervening catalyst between the injector and the SCR catalyst).

In some embodiments, the SCR catalyst includes a substrate and a catalyst composition. The substrate may be a flow-through substrate or a filtering substrate. When the SCR catalyst has a flow-through substrate, then the substrate may comprise the SCR catalyst composition (i.e. the SCR catalyst is obtained by extrusion) or the SCR catalyst composition may be disposed or supported on the substrate (i.e. the SCR catalyst composition is applied onto the substrate by a washcoating method).

When the SCR catalyst has a filtering substrate, then it is a selective catalytic reduction filter catalyst, which is referred to herein by the abbreviation “SCRF”. The SCRF comprises a filtering substrate and the selective catalytic reduction (SCR) composition. References to use of SCR catalysts throughout this application are understood to include use of SCRF catalysts as well, where applicable.

The selective catalytic reduction composition may comprise, or consist essentially of, a metal oxide based SCR catalyst formulation, a molecular sieve based SCR catalyst formulation, or mixture thereof. Such SCR catalyst formulations are known in the art.

The selective catalytic reduction composition may comprise, or consist essentially of, a metal oxide based SCR catalyst formulation. The metal oxide based SCR catalyst formulation comprises vanadium or tungsten or a mixture thereof supported on a refractory oxide. The refractory oxide may be selected from the group consisting of alumina, silica, titania, zirconia, ceria and combinations thereof.

The metal oxide based SCR catalyst formulation may comprise, or consist essentially of, an oxide of vanadium (e.g. V₂O₅) and/or an oxide of tungsten (e.g. WO₃) supported on a refractory oxide selected from the group consisting of titania (e.g. TiO₂), ceria (e.g. CeO₂), and a mixed or composite oxide of cerium and zirconium (e.g. CeₓZr₍₁₋ₓ₎O₂, wherein x=0.1 to 0.9, preferably x=0.2 to 0.5).

When the refractory oxide is titania (e.g. TiO₂), then preferably the concentration of the oxide of vanadium is from 0.5 to 6 wt % (e.g. of the metal oxide based SCR formulation) and/or the concentration of the oxide of tungsten (e.g. WO₃) is from 3 to 15 wt %. More preferably, the oxide of vanadium (e.g. V₂O₅) and the oxide of tungsten (e.g. WO₃) are supported on titania (e.g. TiO₂).

When the refractory oxide is ceria (e.g. CeO₂), then preferably the concentration of the oxide of vanadium is from 0.1 to 9 wt % (e.g. of the metal oxide based SCR formulation) and/or the concentration of the oxide of tungsten (e.g. WO₃) is from 0.1 to 9 wt %.

The metal oxide based SCR catalyst formulation may comprise, or consist essentially of, an oxide of vanadium (e.g. V₂O₅) and optionally an oxide of tungsten (e.g. WO₃), supported on titania (e.g. TiO₂).

The selective catalytic reduction composition may comprise, or consist essentially of, a molecular sieve based SCR catalyst formulation. The molecular sieve based SCR catalyst formulation comprises a molecular sieve, which is optionally a transition metal exchanged molecular sieve. It is preferable that the SCR catalyst formulation comprises a transition metal exchanged molecular sieve.

In general, the molecular sieve based SCR catalyst formulation may comprise a molecular sieve having an aluminosilicate framework (e.g. zeolite), an aluminophosphate framework (e.g. AlPO), a silicoaluminophosphate framework (e.g. SAPO), a heteroatom-containing aluminosilicate framework, a heteroatom-containing aluminophosphate framework (e.g. MeAlPO, where Me is a metal), or a heteroatom-containing silicoaluminophosphate framework (e.g. MeAPSO, where Me is a metal). The heteroatom (i.e. in a heteroatom-containing framework) may be selected from the group consisting of boron (B), gallium (Ga), titanium (Ti), zirconium (Zr), zinc (Zn), iron (Fe), vanadium (V) and combinations of any two or more thereof. It is preferred that the heteroatom is a metal (e.g. each of the above heteroatom-containing frameworks may be a metal-containing framework).

The molecular sieve based SCR catalyst formulation may comprise, or consist essentially of, a molecular sieve having an aluminosilicate framework (e.g. zeolite) or a silicoaluminophosphate framework (e.g. SAPO).

When the molecular sieve has an aluminosilicate framework (e.g. the molecular sieve is a zeolite), then typically the molecular sieve has a silica to alumina molar ratio (SAR) of from 5 to 200 (e.g. 10 to 200), preferably 10 to 100 (e.g. 10 to 30 or 20 to 80), such as 12 to 40, more preferably 15 to 30.

Typically, the molecular sieve is microporous. A microporous molecular sieve has pores with a diameter of less than 2 nm (e.g. in accordance with the IUPAC definition of “microporous” [see Pure & Appl. Chem., 66(8), (1994), 1739-1758)]).

The molecular sieve based SCR catalyst formulation may comprise a small pore molecular sieve (e.g. a molecular sieve having a maximum ring size of eight tetrahedral atoms), a medium pore molecular sieve (e.g. a molecular sieve having a maximum ring size of ten tetrahedral atoms) or a large pore molecular sieve (e.g. a molecular sieve having a maximum ring size of twelve tetrahedral atoms) or a combination of two or more thereof.

When the molecular sieve is a small pore molecular sieve, then the small pore molecular sieve may have a framework structure represented by a Framework Type Code (FTC) selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, LTA, KFI, MER, MON, NSI, OWE, PAU, PHI, RHO, RTH, SAT, SAV, SFW, SIV, THO, TSC, UEI, UFI, VNI, YUG and ZON, or a mixture and/or an intergrowth of two or more thereof. Preferably, the small pore molecular sieve has a framework structure represented by a FTC selected from the group consisting of CHA, LEV, AEI, AFX, ERI, LTA, SFW, KFI, DDR and ITE. More preferably, the small pore molecular sieve has a framework structure represented by a FTC selected from the group consisting of CHA and AEI. The small pore molecular sieve may have a framework structure represented by the FTC CHA. The small pore molecular sieve may have a framework structure represented by the FTC AEI. When the small pore molecular sieve is a zeolite and has a framework represented by the FTC CHA, then the zeolite may be chabazite.

When the molecular sieve is a medium pore molecular sieve, then the medium pore molecular sieve may have a framework structure represented by a Framework Type Code (FTC) selected from the group consisting of AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, −PAR, PCR, PON, PUN, RRO, RSN, SFF, SFG, STF, STI, STT, STW, −SVR, SZR, TER, TON, TUN, UOS, VSV, WEI and WEN, or a mixture and/or an intergrowth of two or more thereof. Preferably, the medium pore molecular sieve has a framework structure represented by a FTC selected from the group consisting of FER, MEL, MFI, and STT. More preferably, the medium pore molecular sieve has a framework structure represented by a FTC selected from the group consisting of FER and MFI, particularly MFI. When the medium pore molecular sieve is a zeolite and has a framework represented by the FTC FER or MFI, then the zeolite may be ferrierite, silicalite or ZSM-5.

When the molecular sieve is a large pore molecular sieve, then the large pore molecular sieve may have a framework structure represented by a Framework Type Code (FTC) selected from the group consisting of AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, −RON, RWY, SAF, SAO, SBE, SBS, SBT, SEW, SFE, SFO, SFS, SFV, SOF, SOS, STO, SSF, SSY, USI, UWY, and VET, or a mixture and/or an intergrowth of two or more thereof. Preferably, the large pore molecular sieve has a framework structure represented by a FTC selected from the group consisting of AFI, BEA, MAZ, MOR, and OFF. More preferably, the large pore molecular sieve has a framework structure represented by a FTC selected from the group consisting of BEA, MOR and MFI. When the large pore molecular sieve is a zeolite and has a framework represented by the FTC BEA, FAU or MOR, then the zeolite may be a beta zeolite, faujasite, zeolite Y, zeolite X or mordenite.

The molecular sieve based SCR catalyst formulation preferably comprises a transition metal exchanged molecular sieve. The transition metal may be selected from the group consisting of cobalt, copper, iron, manganese, nickel, palladium, platinum, ruthenium and rhenium.

The transition metal may be copper. An advantage of SCR catalyst formulations containing a copper exchanged molecular sieve is that such formulations have excellent low temperature NOₓ reduction activity (e.g. it may be superior to the low temperature NOₓ reduction activity of an iron exchanged molecular sieve). Cu-SCR catalyst formulations may include, for example, Cu exchanged SAPO-34, Cu exchanged CHA zeolite, Cu exchanged AEI zeolites, Cu exchanged FER zeolites, or combinations thereof.

The transition metal may be present on an extra-framework site on the external surface of the molecular sieve or within a channel, cavity or cage of the molecular sieve.

Typically, the transition metal exchanged molecular sieve comprises the transition metal in an amount of 0.10 to 10 wt % of the transition metal exchanged molecular sieve, preferably an amount of 0.2 to 5 wt % of the transition metal exchanged molecular sieve.

In general, the selective catalytic reduction catalyst comprises the selective catalytic reduction composition in a total loading of 0.5 to 4.0 g in³, preferably 1.0 to 3.0 g in³.

The SCR catalyst composition may comprise a mixture of a metal oxide based SCR catalyst formulation and a molecular sieve based SCR catalyst formulation. A suitable metal oxide based SCR catalyst formulation may comprise, consist of, or consist essentially of, an oxide of vanadium (e.g. V₂O₅) and optionally an oxide of tungsten (e.g. WO₃), supported on titania (e.g. TiO₂). A suitable molecular sieve based SCR catalyst formulation may comprise a transition metal exchanged molecular sieve.

When the SCR catalyst is an SCRF, then the filtering substrate may preferably be a wall flow filter substrate monolith. The wall flow filter substrate monolith (e.g. of the SCR-DPF) typically has a cell density of 60 to 400 cells per square inch (cpsi). It is preferred that the wall flow filter substrate monolith has a cell density of 100 to 350 cpsi, more preferably 200 to 300 cpsi.

The wall flow filter substrate monolith may have a wall thickness (e.g. average internal wall thickness) of 0.20 to 0.50 mm, preferably 0.25 to 0.35 mm (e.g. about 0.30 mm).

Generally, the uncoated wall flow filter substrate monolith has a porosity of from 50 to 80%, preferably 55 to 75%, and more preferably 60 to 70%.

The uncoated wall flow filter substrate monolith typically has a mean pore size of at least 5 μm. It is preferred that the mean pore size is from 10 to 40 μm, such as 15 to 35 μm, more preferably 20 to 30 μm.

The wall flow filter substrate may have a symmetric cell design or an asymmetric cell design.

In general for an SCRF, the selective catalytic reduction composition is disposed within the wall of the wall-flow filter substrate monolith. Additionally, the selective catalytic reduction composition may be disposed on the walls of the inlet channels and/or on the walls of the outlet channels.

Coatings and Configurations

Embodiments of the present invention may include a coating including an SCR catalyst and a coating including an ASC. In some embodiments, the SCR catalyst is included in a second catalyst coating and the ASC is included in a first catalyst coating. The second catalyst coating may comprise, consist essentially of, or consist of an SCR catalyst. The first catalyst coating may comprise, consist essentially of, or consist of a blend of 1) a platinum group metal on a support, and 2) a molecular sieve. In some embodiments, the use of molecular sieves and metal exchanged molecular sieves in ASC technologies may improve both the NH₃ removal and N₂ selectivity. Such concept may work because it introduces an alternative mechanism for NH₃ removal to challenge the oxidation reaction, particularly below about 400° C. It is at these temperatures when N₂O is a dominant product of NH₃ oxidation. It has surprisingly been found that including an ammonia-storing component in an oxidative layer may provide benefits because the NH₃ may either be oxidized or stored; at higher temperatures, the NH₃ is released, and will then function to remove NOx.

In some embodiments, the first catalyst coating and the second catalyst coating overlap to form three zones: a first zone to primarily remove NOx, a second zone to primarily oxidize ammonia to N₂, and a third zone to primarily oxidize carbon monoxide and hydrocarbons. In some embodiments, the first catalyst coating and the second catalyst coating are configured to form two zones: a first zone to primarily remove NOx, and a second zone to primarily oxidize ammonia to N₂.

In some embodiments, the SCR catalyst includes a Cu-SCR catalyst comprising copper and a molecular sieve, and/or a Fe-SCR catalyst comprising iron and a molecular sieve. Typically, the transition metal exchanged molecular sieve comprises the transition metal in an amount of 0.10 to 10 wt % of the transition metal exchanged molecular sieve, 0.10 to 8 wt % of the transition metal exchanged molecular sieve, 0.20 to 7 wt % of the transition metal exchanged molecular sieve, preferably an amount of 0.2 to 5 wt % of the transition metal exchanged molecular sieve. In general, the selective catalytic reduction catalyst comprises the selective catalytic reduction composition in a total loading of 0.5 to 4.0 g in³, preferably 1.0 to 3.0 g in³.

As described herein, the first catalyst coating includes a blend of 1) a platinum group metal on a support, and 2) a molecular sieve. In some embodiments, the first catalyst coating includes platinum on a support, where the support comprises a metal oxide, gamma alumina, silica titania such as silica (12%) titania (88%), silica, titania, and/or Me-doped alumina or titania where Me could be a metal from the list W, Mn, Fe, Bi, Ba, La, Ce, Zr, or mixtures of two or more thereof. In some embodiments, the first catalyst coating may comprise platinum supported on a molecular sieve such as a zeolite. Suitable molecular sieves for such support may include, for example, FER, BEA, CHA, AEI, MOR, MFI, and mixtures and intergrowths thereof.

In some embodiments, the molecular sieve in the first catalyst coating is a zeolite. In some embodiments, the molecular sieve includes a metal exchanged molecular sieve; the metal may include, for example, copper and/or iron. In some embodiments, a suitable molecular sieve includes, for example, FER, BEA, CHA, AEI, MOR, MFI, and mixtures and intergrowths thereof.

The first catalyst coating may include platinum in an amount of about 1 g/ft³ to about 10 g/ft³; about 1 g/ft³ to about 5 g/ft³; about 1 g/ft³ to about 3 g/ft³; about 1 g/ft³; about 2 g/ft³; about 3 g/ft³; about 4 g/ft³; about 5 g/ft³; about 6 g/ft³; about 7 g/ft³; about 8 g/ft³; about 9 g/ft³; or about 10 g/ft³, relative to the total volume of the first catalyst coating. The first catalyst coating may include a molecular sieve in an amount of about 0.1 g/in³ to about 5 g/in³; about 0.2 g/in³ to about 4 g/in³; about 0.2 g/in³ to about 0.5 g/in³; about 1 g/in³ to about 5 g/in³; about 2 g/in³ to about 4 g/in³; about 0.1 g/in³; about 0.2 g/in³; about 0.3 g/in³; about 0.4 g/in³; about 0.5 g/in³; about 1 g/in³; about 1.5 g/in³; about 2 g/in³; about 3 g/in³; about 4 g/in³; or about 5 g/in³, relative to the total volume of the first catalyst coating. When the support does not comprise a molecular sieve, the first catalyst coating may include a molecular sieve in an amount of about 0.1 g/in³ to about 2 g/in³; about 0.1 g/in³ to about 1 g/in³; about 0.1 g/in³ to about 0.5 g/in³; about 0.2 g/in³ to about 0.5 g/in³; about 0.1 g/in³; about 0.2 g/in³; about 0.3 g/in³; about 0.4 g/in³; about 0.5 g/in³; about 1 g/in³; about 1.5 g/in³; or about 2 g/in³, relative to the total volume of the first catalyst coating. When the support does comprise a molecular sieve, the first catalyst coating may include a molecular sieve in an amount of about 0.1 g/in³ to about 5 g/in³; about 1 g/in³ to about 5 g/in³; about 1.5 g/in³ to about 4.5 g/in³; about 2 g/in³ to about 4 g/in³; about 0.1 g/in³; about 0.5 g/in³; about 1 g/in³; about 2 g/in³; about 3 g/in³; about 4 g/in³; or about 5 g/in³, relative to the total volume of the first catalyst coating.

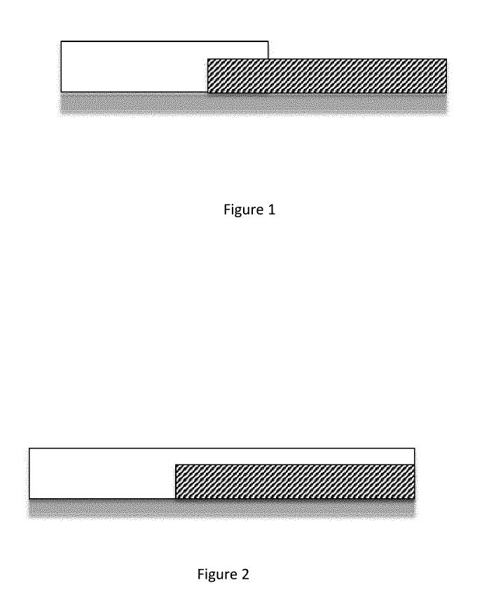

With reference to FIG. 1, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating extends from the outlet end toward the inlet end, covering less than the entire axial length of the substrate, and the second catalyst coating extends from the inlet end toward the outlet end, covering less than the entire axial length of the substrate and overlapping a portion of the first catalyst coating.

With reference to FIG. 2, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating extends from the outlet end toward the inlet end, covering less than the entire axial length of the substrate, and the second catalyst coating covers the entire axial length of the substrate and overlaps the first catalyst coating.

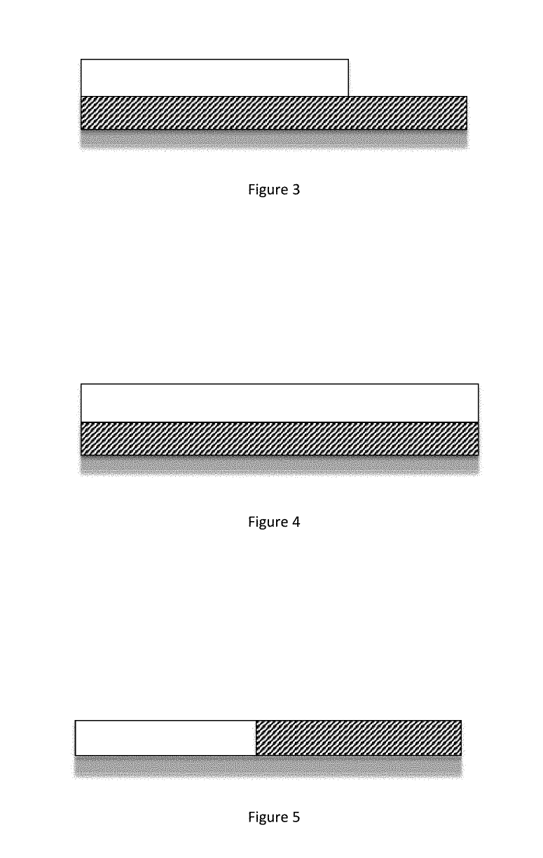

With reference to FIG. 3, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating covers the entire axial length of the substrate, and the second catalyst coating extends from the inlet end toward the outlet end, covering less than the entire axial length of the substrate and overlapping a portion of the first catalyst coating.

With reference to FIG. 4, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating covers the entire axial length of the substrate, and the second catalyst coating covers the entire axial length of the substrate and overlaps the first catalyst coating.

With reference to FIG. 5, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating extends from the outlet end toward the inlet end, covering less than the entire axial length of the substrate, and the second catalyst coating extends from the inlet end toward the outlet end and covering less than the entire axial length of the substrate, and where the first and second catalyst coating do not overlap.

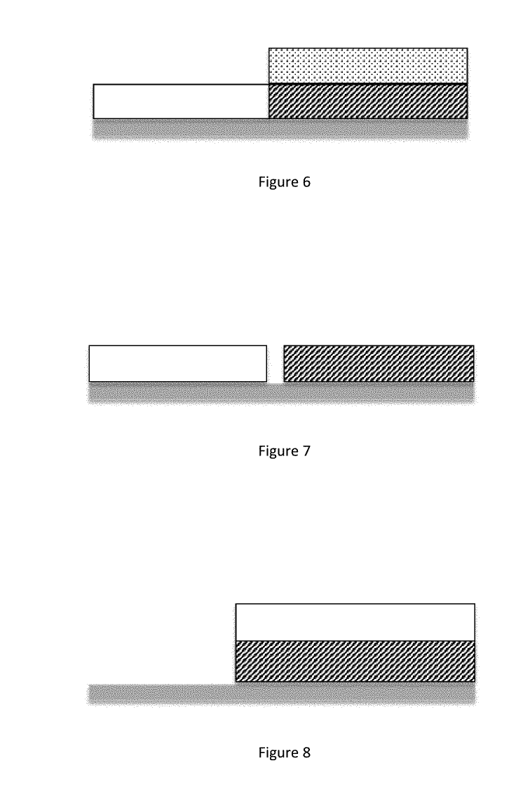

With reference to FIG. 6, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating extends from the outlet end toward the inlet end, covering less than the entire axial length of the substrate, and the second catalyst coating extends from the inlet end toward the outlet end and covering less than the entire axial length of the substrate, where the first and second catalyst coatings do not overlap, and where the catalyst includes a further catalyst coating covering at least part of the first catalyst coating.

With reference to FIG. 7, catalytic articles of embodiments of the present invention may include a first catalyst coating including a blend of 1) Pt on a support, and 2) a molecular sieve, and a second catalyst coating including an SCR catalyst. The catalytic article may be configured such that the first catalyst coating extends from the outlet end toward the inlet end, covering less than the entire axial length of the substrate, and the second catalyst coating covers less than the entire axial length of the substrate, where the first and second catalyst coating do not overlap and where a gap exists between the first and second coating.

With reference to FIG. 8, catalytic articles of embodiments of the present invention may include coatings on an extruded SCR catalyst. The first catalyst coating, having a blend of 1) Pt on a support, and 2) a molecular sieve, may extend from the outlet end toward the inlet end, covering less than the entire axial length of the substrate, and the second catalyst coating, having an SCR catalyst, may extend from the outlet end toward the inlet end, covering less than the entire axial length of the substrate, with the second catalyst coating covering all or a portion of the first catalyst coating.

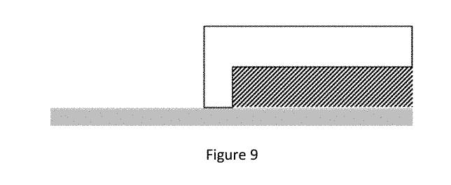

With reference to FIG. 9, catalytic articles of embodiments of the present invention may be coated on an extruded SCR catalyst. The first catalyst coating, having a blend of 1) Pt on a support, and 2) a molecular sieve, may extend from the outlet end toward the inlet end, covering less than the entire axial length of the substrate, and the second catalyst coating, having an SCR catalyst, may extend from the outlet end toward the inlet end, covering less than the entire axial length of the substrate, with the second catalyst coating covering the first catalyst coating and extending some distance beyond the first catalyst coating but not covering the entire axial length of the substrate.

DOC

Catalyst articles and systems of the present invention may include one or more diesel oxidation catalysts. Oxidation catalysts, and in particular diesel oxidation catalysts (DOCs), are well-known in the art. Oxidation catalysts are designed to oxidize CO to CO₂ and gas phase hydrocarbons (HC) and an organic fraction of diesel particulates (soluble organic fraction) to CO₂ and H₂O. Typical oxidation catalysts include platinum and optionally also palladium on a high surface area inorganic oxide support, such as alumina, silica-alumina and a zeolite.

Substrate

Catalysts of the present invention may each further comprise a flow-through substrate or filter substrate. In one embodiment, the catalyst may be coated onto the flow-through or filter substrate, and preferably deposited on the flow-through or filter substrate using a washcoat procedure.

The combination of an SCR catalyst and a filter is known as a selective catalytic reduction filter (SCRF catalyst). An SCRF catalyst is a single-substrate device that combines the functionality of an SCR and particulate filter, and is suitable for embodiments of the present invention as desired. Description of and references to the SCR catalyst throughout this application are understood to include the SCRF catalyst as well, where applicable.

The flow-through or filter substrate is a substrate that is capable of containing catalyst/adsorber components. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates, metallo aluminosilicates (such as cordierite and spudomene), or a mixture or mixed oxide of any two or more thereof. Cordierite, a magnesium aluminosilicate, and silicon carbide are particularly preferred.

The metallic substrates may be made of any suitable metal, and in particular heat-resistant metals and metal alloys such as titanium and stainless steel as well as ferritic alloys containing iron, nickel, chromium, and/or aluminum in addition to other trace metals.

The flow-through substrate is preferably a flow-through monolith having a honeycomb structure with many small, parallel thin-walled channels running axially through the substrate and extending throughout from an inlet or an outlet of the substrate. The channel cross-section of the substrate may be any shape, but is preferably square, sinusoidal, triangular, rectangular, hexagonal, trapezoidal, circular, or oval. The flow-through substrate may also be high porosity which allows the catalyst to penetrate into the substrate walls.

The filter substrate is preferably a wall-flow monolith filter. The channels of a wall-flow filter are alternately blocked, which allow the exhaust gas stream to enter a channel from the inlet, then flow through the channel walls, and exit the filter from a different channel leading to the outlet. Particulates in the exhaust gas stream are thus trapped in the filter.

The catalyst/adsorber may be added to the flow-through or filter substrate by any known means, such as a washcoat procedure.

Reductant/Urea Injector

The system may include a means for introducing a nitrogenous reductant into the exhaust system upstream of an SCR and/or SCRF catalyst. It may be preferred that the means for introducing a nitrogenous reductant into the exhaust system is directly upstream of the SCR or SCRF catalyst (e.g. there is no intervening catalyst between the means for introducing a nitrogenous reductant and the SCR or SCRF catalyst).

The reductant is added to the flowing exhaust gas by any suitable means for introducing the reductant into the exhaust gas. Suitable means include an injector, sprayer, or feeder. Such means are well known in the art.

The nitrogenous reductant for use in the system can be ammonia per se, hydrazine, or an ammonia precursor selected from the group consisting of urea, ammonium carbonate, ammonium carbamate, ammonium hydrogen carbonate, and ammonium formate. Urea is particularly preferred.

The exhaust system may also comprise a means for controlling the introduction of reductant into the exhaust gas in order to reduce NOx therein. Preferred control means may include an electronic control unit, optionally an engine control unit, and may additionally comprise a NOx sensor located downstream of the NO reduction catalyst.

Systems and Methods

Emissions treatment systems of the present invention may include a diesel engine emitting an exhaust stream including particulate matter, NOx, and carbon monoxide, and a catalytic article as described herein. A system may include an SCR catalyst upstream of the catalytic article. In some embodiments, the SCR catalyst is close-coupled with the catalytic article. In some embodiments, the SCR catalyst and the catalytic article are located on a single substrate, and the SCR catalyst is located on an inlet side of the substrate and the catalytic article is located on the outlet side of the substrate.

Methods of the present invention may include contacting the exhaust stream with a catalytic article as described herein.

Benefits

Traditionally, catalyst articles have included SCR functionality in the top or front layer, and ASC functionality in a bottom or rear layer. In catalysts of embodiments of the present invention, the catalyst coatings may be arranged such that the exhaust gas contacts the second catalyst coating before contacting the first catalyst coating. It has surprisingly been found that including a molecular sieve in both a first and second layer provides various benefits and advantages to NH₃ conversion, as well as zoned ASC configurations with desirable selectivity and catalyst activity. Specifically, incorporating molecular sieves such as zeolites and metal-zeolites into the oxidation component of an ASC may improve NH₃ abatement as well as the selectivity to N₂.

In some embodiments, inclusion of a molecular sieve in the first catalyst coating may provide benefits by introducing an alternative mechanism for NH₃ removal to challenge the oxidation reaction. In some embodiments, such benefits are particularly advantageous at temperatures when N₂O is a dominant product of NH₃ oxidation, such as below about 400° C. It has surprisingly been found that including an ammonia-storing component in an oxidative layer may provide benefits because the NH₃ may either be oxidized or stored; at higher temperatures, the NH₃ is released, and will then function to remove NOx.

As used in this specification and the appended claims, the singular forms “a”, “an” and “the” include plural referents unless the context clearly indicates otherwise. Thus, for example, reference to “a catalyst” includes a mixture of two or more catalysts, and the like.

The term “ammonia slip”, means the amount of unreacted ammonia that passes through the SCR catalyst.

The term “support” means the material to which a catalyst is fixed.

The term “calcine”, or “calcination”, means heating the material in air or oxygen. This definition is consistent with the IUPAC definition of calcination. (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. doi:10.1351/goldbook.) Calcination is performed to decompose a metal salt and promote the exchange of metal ions within the catalyst and also to adhere the catalyst to a substrate. The temperatures used in calcination depend upon the components in the material to be calcined and generally are between about 400° C. to about 900° C. for approximately 1 to 8 hours. In some cases, calcination can be performed up to a temperature of about 1200° C. In applications involving the processes described herein, calcinations are generally performed at temperatures from about 400° C. to about 700° C. for approximately 1 to 8 hours, preferably at temperatures from about 400° C. to about 650° C. for approximately 1 to 4 hours.

When a range, or ranges, for various numerical elements are provided, the range, or ranges, can include the values, unless otherwise specified.

The term “N₂ selectivity” means the percent conversion of ammonia into nitrogen.

The terms “diesel oxidation catalyst” (DOC), “diesel exotherm catalyst” (DEC), “NOx absorber”, “SCR/PNA” (selective catalytic reduction/passive NOx adsorber), “cold-start catalyst” (CSC) and “three-way catalyst” (TWC) are well known terms in the art used to describe various types of catalysts used to treat exhaust gases from combustion processes.

The term “platinum group metal” or “PGM” refers to platinum, palladium, ruthenium, rhodium, osmium and iridium. The platinum group metals are preferably platinum, palladium, ruthenium or rhodium.

The terms “downstream” and “upstream” describe the orientation of a catalyst or substrate where the flow of exhaust gas is from the inlet end to the outlet end of the substrate or article.

### EXAMPLES

### Example 1

Catalyst A was prepared, including the following:

| | | |
|---|---|---|
| Component | Loading | Role within the catalyst |

Lower layer

| | | |
|---|---|---|
| Alumina | 0.3 g/in³ | Support material for Pt |
| Dispersing agent | As necessary | Ensure good dispersion of PGM |
| Pt-salt | 3 g/ft³ | NH₃ oxidation activity |
| Zeolite | 0.5 g/in³ | NH₃ storage - reduce N₂O |
| | | selectivity |
| Binder | As necessary | Ensure good adhesion and |
| | | cohesion of the catalyst coating |

Top layer

| | | |
|---|---|---|
| Binder | As necessary | Ensure good adhesion and |
| | | cohesion of the catalyst coating |
| Cu-CHA | 2 g/in³ | SCR function - reduce NOₓ |
| | | selectivity |
| | | NH₃ storage - reduce N₂O |
| | | selectivity |

A comparative Catalyst B was prepared, differing from Catalyst A in that it does not contain the zeolite or binder in the lower layer.

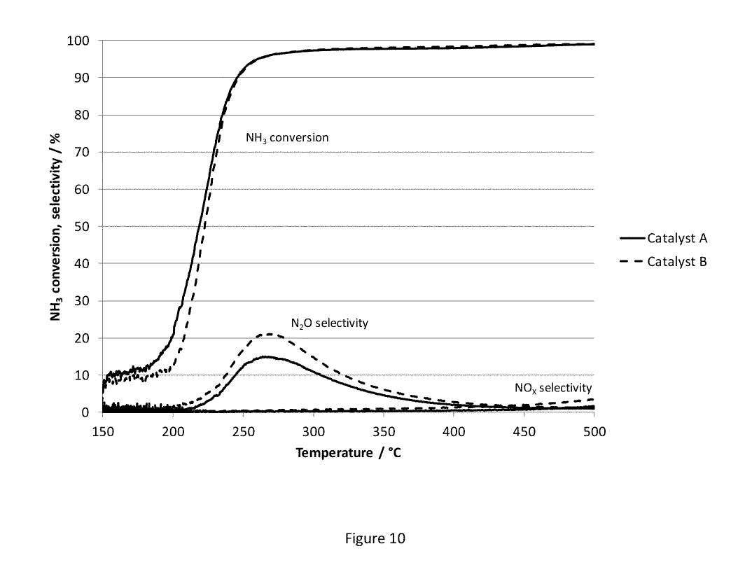

Catalyst A and Catalyst B were tested for NH₃ conversion and N₂ selectivity. As shown in the FIG. 10, Catalyst A and Catalyst B demonstrate comparable NH₃ conversion, however, Catalyst A (which includes the zeolite in the lower layer) provides a 25% reduction of peak N₂O emissions compared to Catalyst B.

1. A catalyst comprising a first catalyst coating and a second catalyst coating,
the first catalyst coating comprising a blend of 1) Pt on a support, and 2) a molecular sieve, and
the second catalyst coating comprising an SCR catalyst.

2. The catalyst of claim 1, wherein the SCR catalyst comprises a Cu-SCR catalyst comprising copper and a molecular sieve, and/or an Fe-SCR catalyst comprising iron and a molecular sieve.

3. The catalyst of claim 1, wherein the support comprises silica, titania, and/or Me-doped alumina or titania where Me comprises a metal selected from W, Mn, Fe, Bi, Ba, La, Ce, Zr, or mixtures of two or more thereof.

4. The catalyst of claim 1, wherein the molecular sieve comprises FER, BEA, CHA, AEI, MOR, MFI, and mixtures and intergrowths thereof.

5. The catalyst of claim 1, wherein the Pt is present in an amount of about 1 g/ft³ to about 10 g/ft³ relative to the weight of the first catalyst coating.

6. The catalyst of claim 1, wherein the molecular sieve is present in an amount of up to about 2 g/in³ relative to the weight of the first catalyst coating.

7. The catalyst of claim 1, wherein the first and second catalyst coatings are configured such that exhaust gas contacts the second catalyst coating before contacting the first catalyst coating.

8. The catalyst of claim 1, wherein the second catalyst coating completely overlaps the first catalyst coating.

9. The catalyst of claim 1, wherein the second catalyst coating partially overlaps the first catalyst coating.

10. The catalyst of claim 1, wherein the first catalyst coating and the second catalyst coating do not overlap.

11. The catalyst of claim 1, wherein the first catalyst coating comprises a platinum group metal on the molecular sieve.

12. The catalyst of claim 1, wherein the molecular sieve comprises a metal exchanged molecular sieve.

13. The catalyst of claim 11, wherein the metal comprises copper and/or iron.

14. A catalytic article comprising the catalyst of claim 1 and a substrate.

15. The article of claim 14, wherein the substrate is cordierite, a high porosity cordierite, a metallic substrate, an extruded SCR, a wall flow filter, a filter, or an SCRF.

16. An emissions treatment system comprising:
a. a diesel engine emitting an exhaust stream including particulate matter, NOx, and carbon monoxide;
b. the catalyst of any of the preceding claims (“the SCR/ASC”).

17. The system of claim 16, further comprising an upstream SCR catalyst upstream of the SCR/ASC.

18. The system of claim 16, wherein the upstream SCR catalyst is close-coupled with the SCR/ASC.

19. The system of claim 16, wherein the upstream SCR catalyst and the SCR/ASC catalyst are located on a single substrate, and the upstream SCR catalyst is located on an inlet side of the substrate and the SCR/ASC catalyst is located on the outlet side of the substrate.

20. A method of reducing emissions from an exhaust stream, comprising contacting the exhaust stream with the catalyst of claim 1.

21. The method of claim 20, wherein the catalyst provides lower peak N₂O emissions compared to a catalyst which is equivalent except does not include a molecular sieve in the first catalyst coating.

22. The method of claim 20, wherein the catalyst provides at least about 25% reduction in peak N₂O emissions compared to a catalyst which is equivalent except does not include a molecular sieve in the first catalyst coating.
